(19) United States
(12) Patent Application Publication
(10) Pub. No.: US 2007/0099563 A1
(43) Pub. Date: May 3, 2007

(54) Network configuring device and network configuring method

(76) Inventors: Kouichirou Amemiya, Kawasaki (JP); Toshiki Tanaka, Kawasaki (JP); Hideyuki Miyata, Kawasaki (JP)

Correspondence Address: KATTEN MUCHIN ROSENMAN LLP, 575 MADISON AVENUE, NEW YORK, NY, 10022-2585, US

(21) Appl. No.: 11/341,918

(22) Filed: Jan. 27, 2006

(30) Foreign Application Priority Data
Oct. 31, 2005 (JP) 2005-317489

(51) Int. Cl. H04B 3/58

(52) U.S. Cl. 455/14

(57) ABSTRACT

Before wiring of a physical wiring changing-over switch is switched, a communication suspension instructing unit in a controller sends a signal to instruct IT devices connected to the physical wiring changing-over switch to suspend communications for a certain period of time and hold the communication bit strings to be transmitted in a temporary storage area. The signal is sent via an exclusive control line between the controller and the IT devices.

### BACKGROUND OF THE INVENTION

1. Field of the Invention

The present invention relates to a technology of physically switching routes by a physical wiring changing-over switch.

2. Description of the Related Art

Layer 2 switches and layer 3 switches are employed in network systems. A layer 2 switch changes over a route by referring a MAC address in a read forwarding database (FDB). A layer 3 switch changes over a route by referring an IP address in a read rooting table (RTB).

Use of physical wiring changing-over switches have also be considered to change over the route of signals. U.S. Pat. No. 6,243,510, for example, describes a physical wiring changing-over switch that changes over, with an electrical matrix switch, a route of an electric signal. A given signal received from outside is input in an interface module and the received signal is converted into the electrical signal.

Moreover, Japanese Patent Laid-Open Publication No. 2002-169107 describes another physical wiring changing-over switch that changes over the routes of signals. The route of a signal that is input from an array-type optical fiber is changed-over by using a matrix switch that includes a mirror manufactured with MEMS (Micro electro mechanical systems) technology.

The above physical wiring changing-over switches change over the route of a signal by physically switching wirings. In other words, these physical changing-over switches do not have the function of switching a destination of the signal, such as the Ethernet (trademark) switch, by referring to the content of the signal (MAC address and the like).

When a physical wiring changing-over switch is used to change a connection between IT devices, such as layer 2/3 switches, routers, and servers, sometimes data can be lost during the switching operation. Moreover, when the switching is performed when there is heavy communications, load on the network increases. The reason being that, after the switching, packets that may have been lost during the switching are re-transmitted and/or broadcast packets are transmitted to check the destination of the new route.

### SUMMARY OF THE INVENTION

It is an object of the present invention to at least solve the problems in the conventional technology.

According to an aspect of the present invention, a network configuring device includes a physical wiring switching unit configured to connect a plurality of information devices to each other, the physical wiring switching unit including a plurality of interface units for connecting the information devices; a switch controlling unit that controls the physical wiring switching unit to change connection statuses of the interface units of the physical wiring switching unit and the information devices to thereby changing a network topology of the information devices; and a communication suspension instructing unit that outputs a signal to an information device whereby that information device suspends communications with other information device, wherein the communication suspension instructing unit outputs the signal before the switch controlling unit changes the connection statuses of the interface units.

According to another aspect of the present invention, a method of configuring a network by controlling a physical wiring switching unit configured to connect a plurality of information devices to each other, the physical wiring switching unit including a plurality of interface units for connecting the information devices, includes outputting a signal to an information device whereby that information device suspends communications with other information device; and controlling, after the outputting, the physical wiring switching unit to change connection statuses of the interface units of the physical wiring switching unit and the information devices to thereby changing a network topology of the information devices.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic of a network system according to an embodiment of the present invention;

FIG. 2 is a flowchart of a process procedure performed by a controller shown in FIG. 1 when changing a network configuration;

FIG. 3 is a schematic for explaining transmission of a control signal using a control exclusive line;

FIG. 4 is a schematic for explaining transmission of the control signal using free ports;

FIG. 5 is a flowchart of a process procedure for changing network configuration by the controller shown in FIG. 2 when a control signal is transmitted using connection ports in between IT devices;

FIGS. 6 to 9 are schematics for explaining transmission of a control signal via connection ports of the IT devices;

FIGS. 10 and 11 are schematics of configurations that include two sets of controller and transmitter;

FIGS. 12 and 13 are schematics of configurations that include a control signal inserter;

FIG. 14 is a schematic of internal configuration of the control signal inserters shown in FIGS. 12 and 13;

FIGS. 15 and 16 are schematics of a control signal inserters that include only one set of transmitter and receiver;

FIG. 17 is a schematic of internal configuration of the control signal inserters shown in FIGS. 15 and 16; and

FIG. 18 is a schematic of a control signal inserter that includes only one set of transmitter and receiver.

### DETAILED DESCRIPTION OF THE PREFERRED EMBODIMENTS

Exemplary embodiments of the present invention are described in detail below with reference to the accompanying drawings.

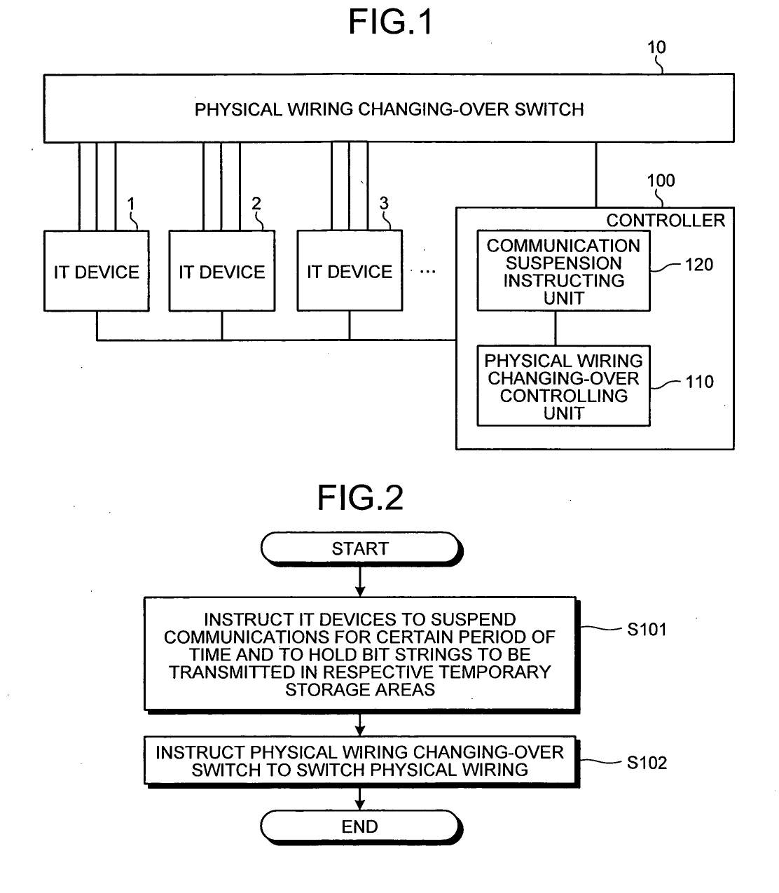

FIG. 1 is a schematic of a network system according to an embodiment of the present invention. The network system includes IT (information technology) devices 1 to 3, a physical wiring changing-over switch 10, and a controller 100.

The IT devices 1 to 3 are connected to the physical wiring changing-over switch 10 with three connection interfaces. The IT devices 1 to 3 are, for example, switches, routers, or servers. Although only three IT devices have been shown, the number of the IT devices is optional. Generally, a lot of IT devices can be connected to a physical wiring changing-over switch. Moreover, although the IT devices have been shown connected with the physical wiring changing-over switch with three connection interfaces, the number of the connection interfaces is optional.

The physical wiring changing-over switch 10 is an electrical switch or an optical switch. The physical wiring changing-over switch 10 provides a one-to-one internal connection to each of connection interfaces in different IT devices. A configuration of the internal connection of the physical wiring changing-over switch 10 can be changed as desired. A topology of a network system can be changed by changing the configuration of the physical wiring changing-over switch 10. The physical wiring changing-over switch 10 does not performing the switching by referring to information relating to a destination in a packet.

The controller 100 controls the internal connection of the physical wiring changing-over switch 10 and transmission of bit strings from the IT devices. The controller includes a physical wiring changing-over controlling unit 110 and a communication suspension instructing unit 120.

The physical wiring changing-over controlling unit 110 instructs the physical wiring changing-over switch 10 to provide a one-to-one internal connection to respective connection interfaces in different IT devices. The physical wiring changing-over controlling unit 110 instructs, for example, the physical wiring changing-over switch 10 to change an internal connection at a prespecified time to automatically change the network topology. The physical wiring changing-over controlling unit 110 can be configured to instruct the physical wiring changing-over switch 10 to change the internal connection based on an instruction for changing the network topology from a network administrator.

The communication suspension instructing unit 120 instructs a first IT device, which is connected to a second IT device via the physical wiring changing-over switch 10, to suspend communications for a certain period of time and to hold communication bit strings to be transmitted in a temporary storage area. This operation is performed before the physical wiring changing-over controlling unit 110 instructs the physical wiring changing-over switch 10 to change the internal connection.

By suspending communications for a certain period of time and holding the communication bit strings to be transmitted in a temporary storage area, loss of communication bit strings can be prevented.

Although the controller 100 is shown to include the physical wiring changing-over controlling unit 110 and the communication suspension instructing unit 120, the physical wiring changing-over controlling unit 110 and the communication suspension instructing unit 120 can be included in two separate controllers.

Although it has been explained above that the communication suspension instructing unit 120 instructs the IT devices to suspend communications, it is possible to employ a configuration in which a communication suspension instructing unit instructs each of the IT devices to suspend the communications. Moreover, the time period for which the communications is suspended can be different in different IT devices. When such a configuration is employed, a time lag is generated in each of the IT devices in resuming the communications. This time lag prevents retransmitted packets, broadcast frames, and the data bit strings accumulated in a temporary storage area from being transmitted at one time. As a result, also it becomes possible to prevent sudden increase of network load when the communications are resumed.

In a network based on the TCP/IP, if packets are lost during switching of the routes, the packets are retransmitted. On the other hand, in a network based on the Ethernet, if packets are lost during switching of the routes, broadcast frames for searching for destinations of the frames are generated. Moreover, the data bit strings that are held in the temporary storage area in each of the IT devices without transmitting are also transmitted at a stroke immediately after the communications are resumed. Thus, a signal that includes a large volume of retransmitted packets, broadcast frames, and accumulated data bit strings is transmitted. Because this signal consumes a considerable bandwidth, transmission of other signals can become troublesome. To solve this problem, in the embodiment, the IT devices resume communications one after the other, which prevents sudden increase in the load in the network.

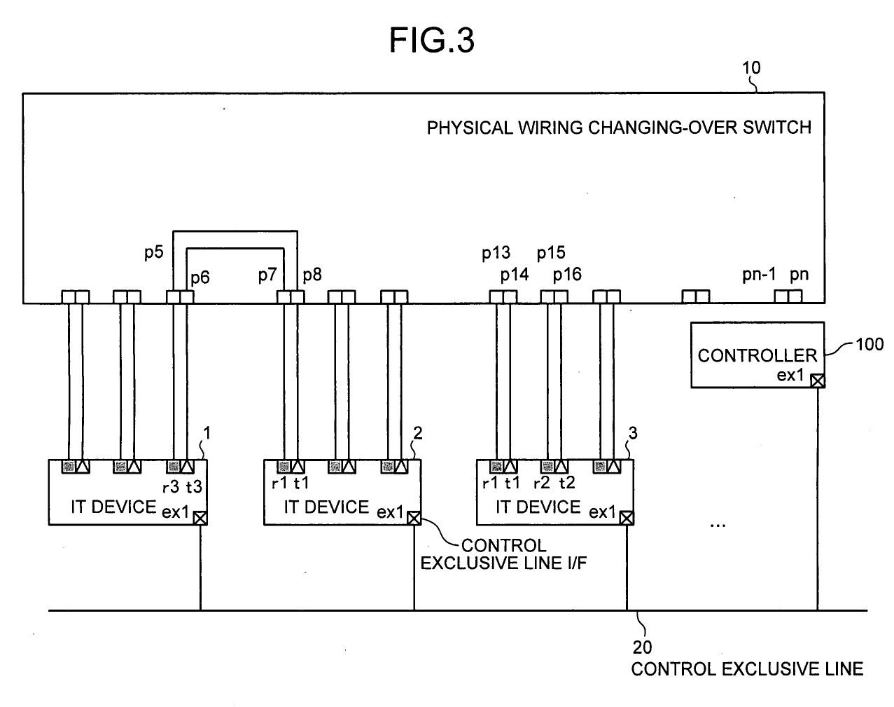

FIG. 2 is a flowchart of a process procedure performed by the controller 100 when changing the network configuration. This processing is performed, for example, at a prespecified time.

The communication suspension instructing unit 120 of the controller 100 instructs the IT devices, which are connected to each other via the physical wiring changing-over switch 10, to suspend communications for a predetermined period of time and to hold communication bit strings to be transmitted in respective temporary storage areas (step S101).

The physical wiring changing-over controlling unit 110 of the controller 100 then instructs the physical wiring changing-over switch 10 to switch the physical wiring (step S102).

Thus, switching of the physical wiring is performed after the IT devices suspend the communications for the predetermined period of time and hold the communication bit strings to be transmitted in respective temporary storage areas. As a result, loss of the communication bit strings can be prevented when performing switching of the physical wiring.

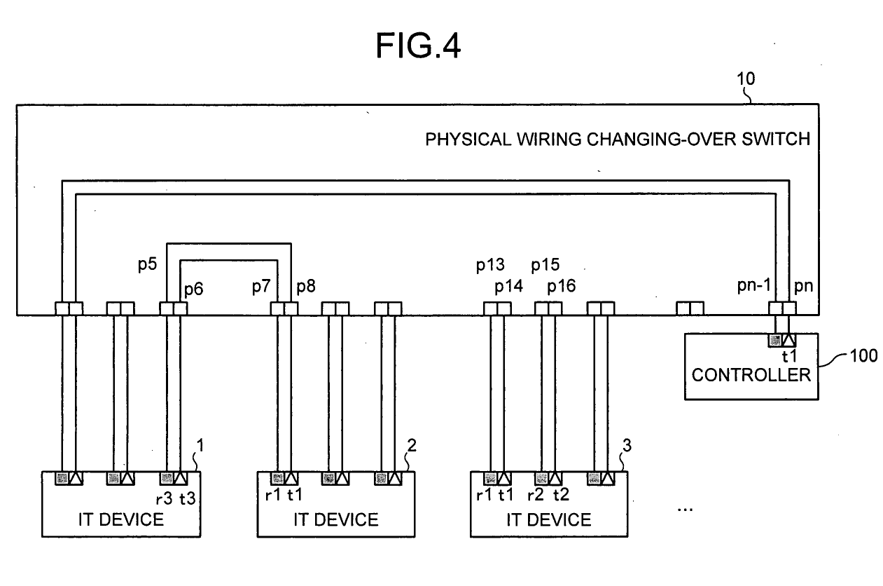

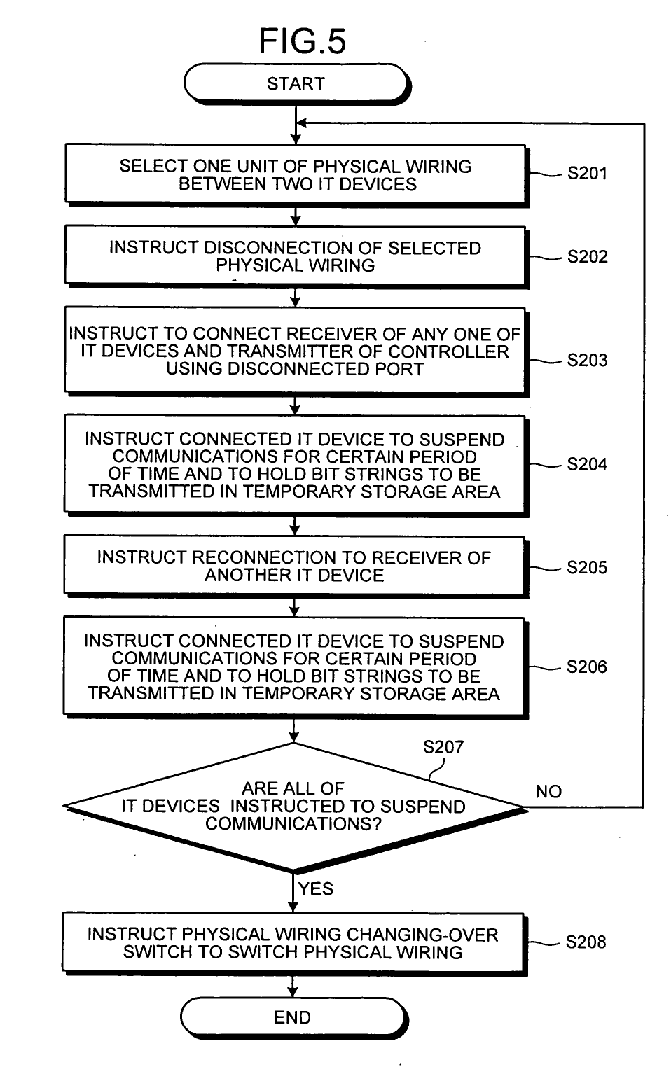

Next, how the communication suspension instructing unit 120 communicates with the IT devices to instruct to suspend communications below with reference to FIG. 3 to FIG. 18. The communication suspension instructing unit 120 communicates with the IT devices by sending a control signal. In these figures, “rn” is a receiver, “tn” a transmitter, “pn” a port of a physical wiring changing-over switch, and “ex1” a control exclusive line interface.

FIG. 3 is a schematic for explaining transmission of the control signal using a control exclusive line. A control exclusive line 20 connects the control exclusive line interfaces of the controller 100 and the IT devices 1 to 3. The controller 100 sends the control signal to the IT devices 1 to 3 via the control exclusive line 20. Each IT device 1 to 3 include a configuration to recognize the control signal, a configuration to suspend the communications for the predetermined period of time, and a configuration to hold the bit strings to be transmitted in a temporary storage.

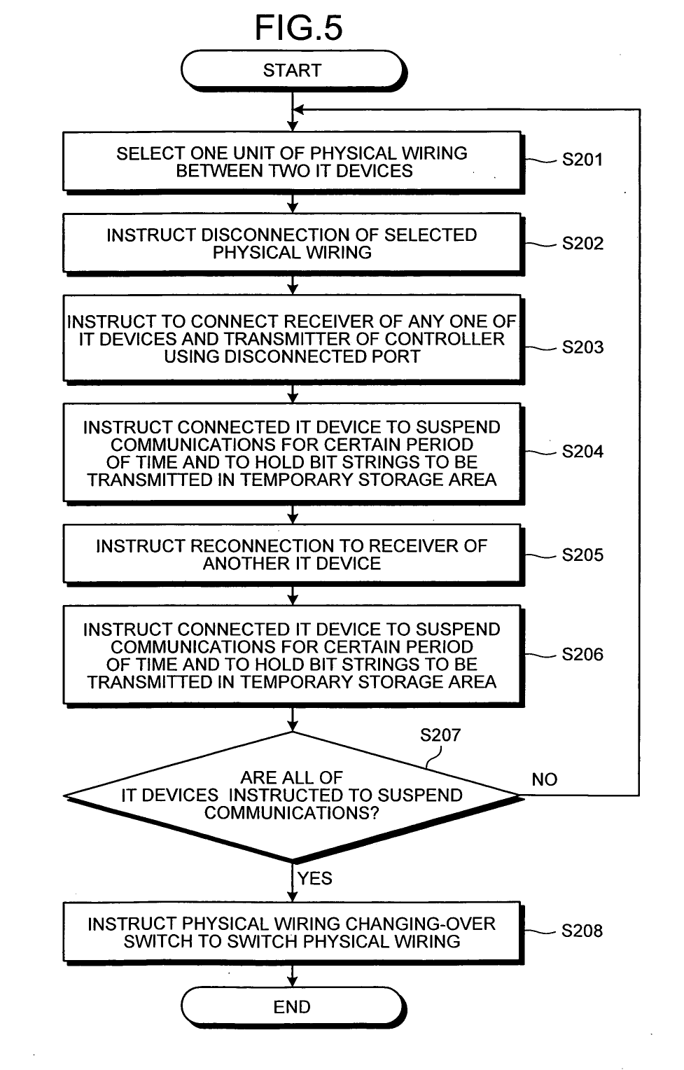

FIG. 4 is a schematic for explaining transmission of the control signal using free ports. The physical wiring changing-over switch 10 includes free ports. The IT devices and the controller 100 are connected to each other using the free ports of the physical wiring changing-over switch 10.

An “r3” and a “t3” in the IT device 1 are connected to an “r1” and a “t1” in the IT device 2, respectively. To change the connection, a control interface on the controller 100 is connected to a control interface on the IT device 1 using the free port of the physical wiring changing-over switch 10. The controller 100 transmits the control signal to the IT device 1 via the free port of the physical wiring changing-over switch 10. The controller 100 repeats the same operation with respect to the IT device 2, and then changes the connection between the IT devices.

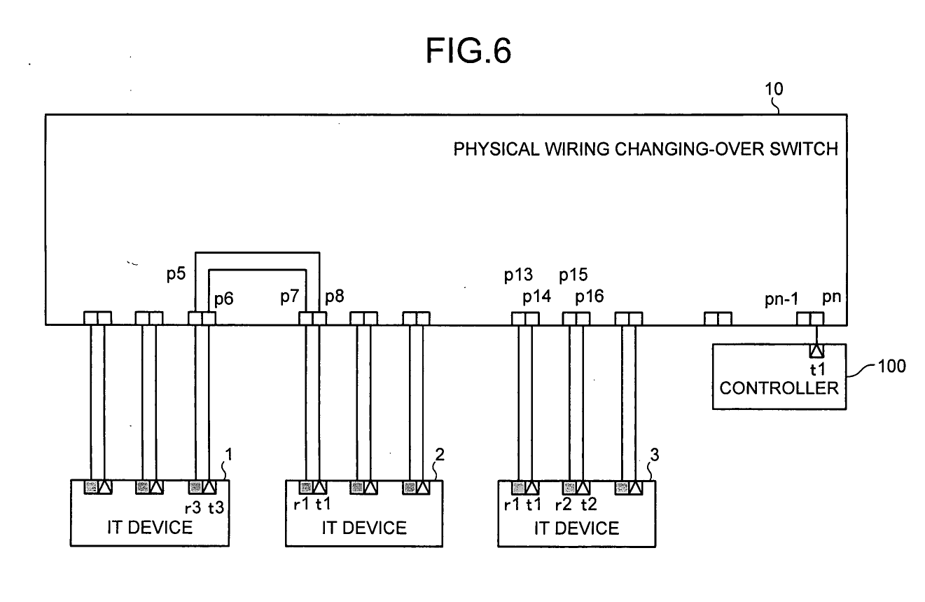

Loss of the bit strings can be prevented without fail with the configurations shown in FIG. 3 and FIG. 4. With the configurations shown in FIG. 5 to FIG. 18, loss of the bit strings can not be completely prevented, however, still, better result can be obtained than not sending the control signal.

FIG. 5 is a flowchart of a process procedure performed by the controller 100 in changing the network configuration when the control signal is transmitted using connection ports in between the IT devices.

The controller 100 selects one unit of physical wiring between two IT devices (step S201), and instructs the IT devices to disconnect the selected unit (step S202).

The controller 100 then instructs the physical wiring changing-over switch 10 to connect a receiver of any one of the IT devices and a transmitter of the controller 100 using the disconnected port (step S203), and instructs the connected IT device to suspend communications for a certain period of time and to hold the bit strings to be transmitted in a temporary storage area (step S204).

The controller 100 instructs the physical wiring changing-over switch 10 to reconnect to a receiver of the other IT device (step S205), and instructs the connected IT device to suspend communications for a certain period of time and to hold the bit strings to be transmitted in a temporary storage area (step S206).

The controller 100 then determines whether all of the IT devices connected to the physical wiring changing-over switch 10 are instructed to suspend the communications before switching the physical wiring (step S207). When an IT device is determined not yet to have received the instruction, the controller 100 returns to the step S201, and selects one unit of physical wiring to be disconnected next. When all of the IT devices are determined to have already received the instruction, the controller 100 instructs the physical wiring changing-over switch 10 to switch-the physical wiring (step S208).

As described above, by transmitting a control signal for instructing a temporal suspension of communications to the IT devices one by one using the connection ports between the IT devices, switching of the physical wiring is instructed after suspending communications of the IT devices one by one, while allowing partial communications by part of the IT devices, so that it is possible to reduce loss of the bit strings to be transmitted as compared to the method with which simultaneous switching of the physical wiring is instructed.

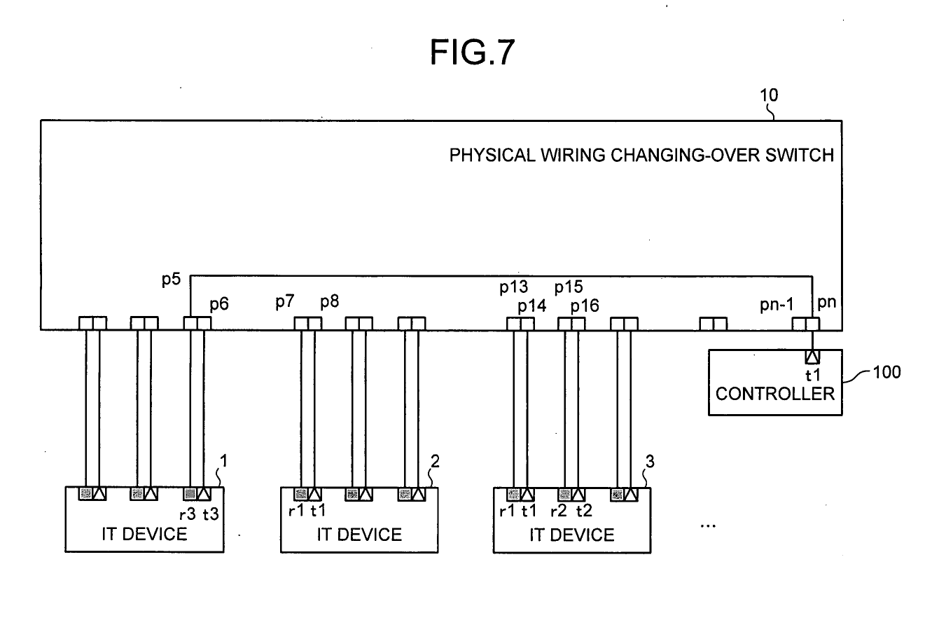

Each of FIG. 6 to FIG. 9 is a schematic for explaining transmission of the control signal using the connection ports in between the IT devices. When a control signal is transmitted using the connection ports in between the IT devices, the controller 100 includes a transmitter. The transmitter and the physical wiring changing-over switch 10 are connected to each other.

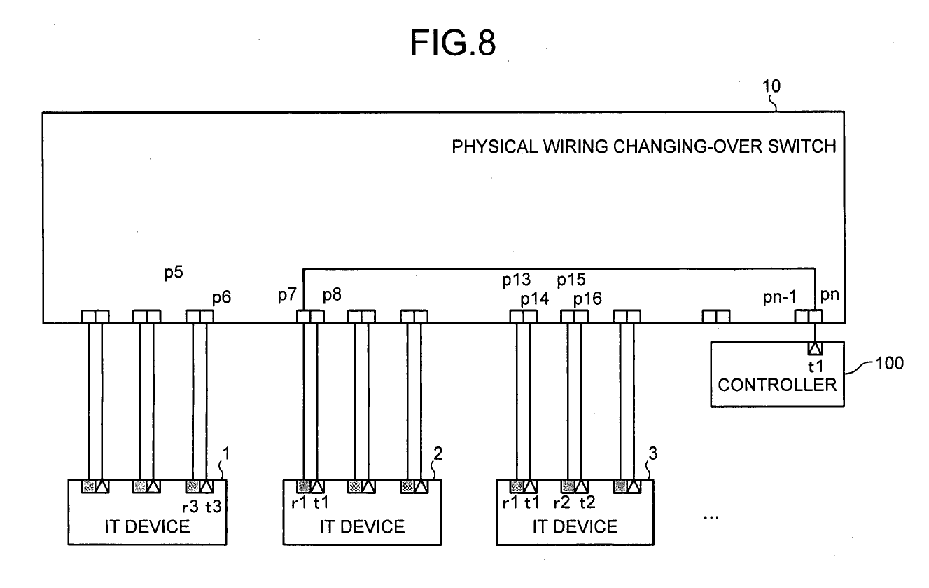

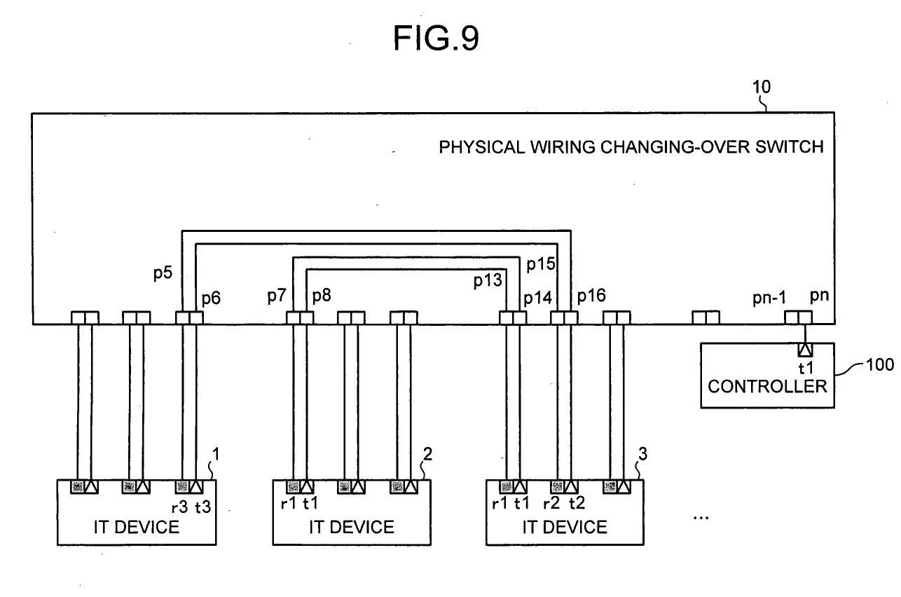

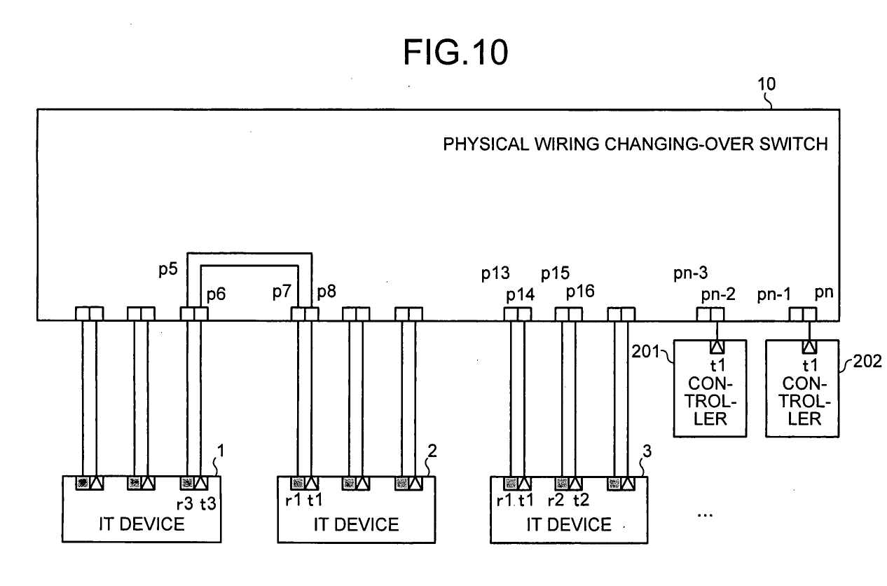

That is, as shown in FIG. 6, an “r3” and a “t3” in the IT device 1 are connected to an “r1” and a “t1” in the IT device 2, respectively. To change this connection, as shown in FIG. 7, the transmitter in the controller 100 is connected to the receiver “r3” in the IT devices 1 via the physical wiring changing-over switch 10. The controller 100 transmits the control signal to the receiver “r3” of the IT device 1, and instructs the receiver “r3” in the IT device 1 to suspend the communications and to hold the bit strings to be transmitted in a temporary storage area. Then, as shown in FIG. 8, the controller 100 repeats the same operation to the receiver “r1” in the IT device 2, and changes the connection-in between the IT devices 1 and 2 as shown in FIG. 9.

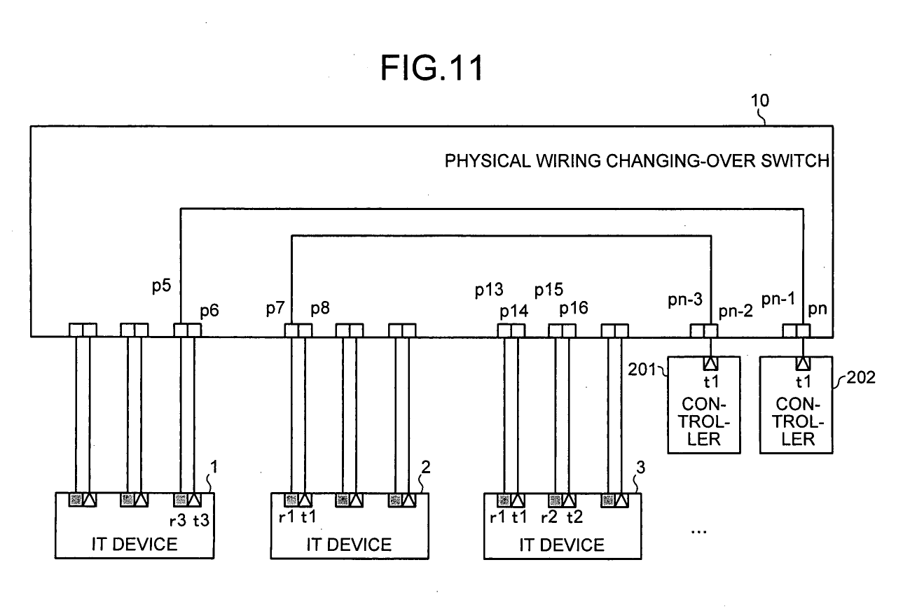

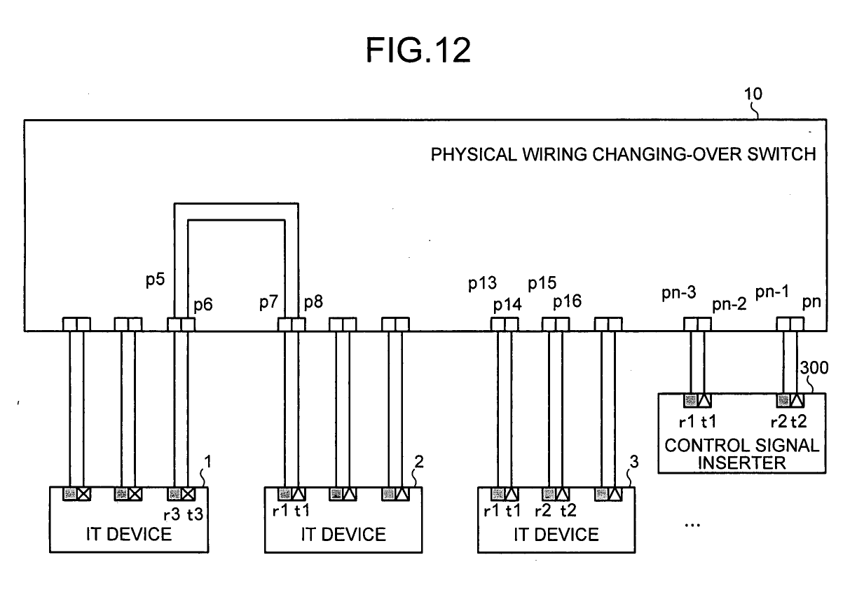

When a control signal is transmitted using the connection ports in between the IT devices, as shown in FIG. 10 and FIG. 11, two sets of controller and transmitter can be provided to simultaneously transmit a control signal for controlling communication to both the IT device 1 and the IT device 2. In this case, however, controllers 201 and 202 do not control switching of the physical wiring, but operate in coordination with another physical wiring switching controller not shown. Alternatively, any one of the controllers 201 and 202 can control switching of the physical wiring.

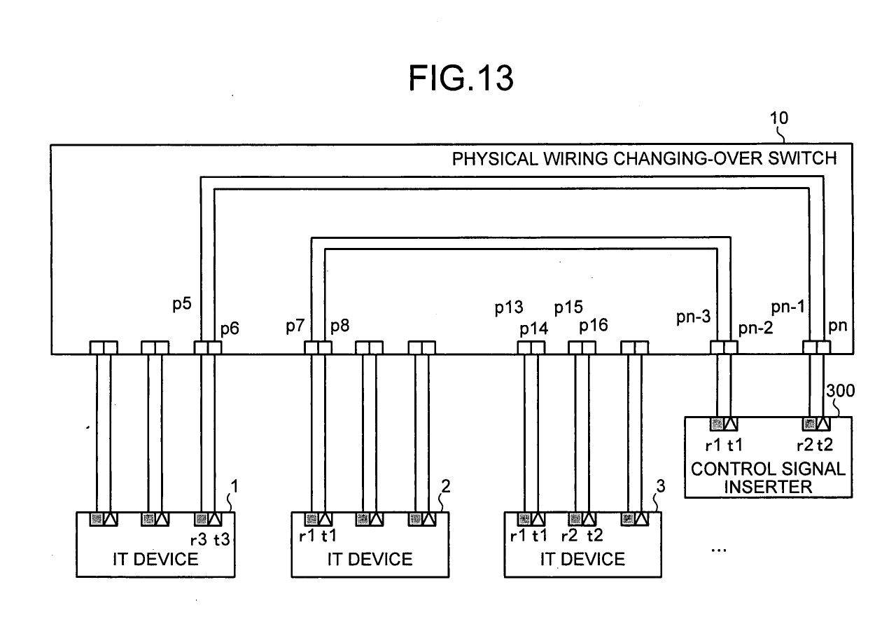

Each of FIG. 12 to FIG. 14 is a schematic of a configuration that includes a control signal inserter. A transmitter and a receiver of any one set provided in a control signal inserter 300 that has two sets of a transmitter and a receiver are connected to a port “pn-3” and a port “pn-2” in the physical wiring changing-over switch 10 respectively, and a transmitter and a receiver of another set are connected to a port “pn-1” and a port “pn” in the physical wiring changing-over switch 10 respectively.

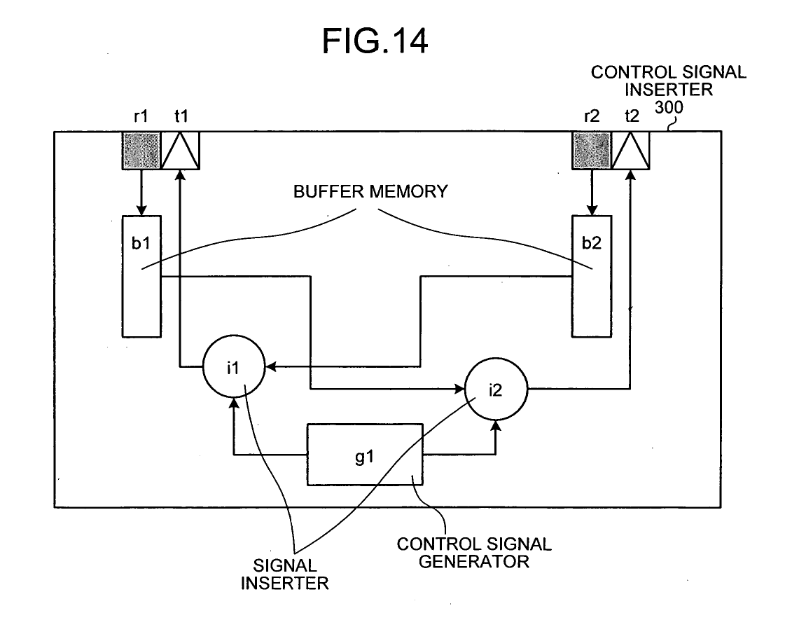

Configuration is assumed in which the “r3” and the “t3” in the IT device 1 are connected to the “r1” and the “t1” in the IT device 2, respectively. To change this connection, as shown in FIG. 13, the transmitter “t3” in the IT device 1 and the receiver “r2” in the control signal inserter 300, as well as the receiver “r3” in the IT device 1 and the transmitter “t2” in the control signal inserter 300 are connected to each other, and the transmitter “t1” in the IT device 2 and the receiver “r1” in the control signal inserter 300, as well as the receiver “r1” in the IT device 2 and the transmitter “t1” in the control signal inserter 300 are connected to each other, both of which are connected via the physical wiring changing-over switch 10.

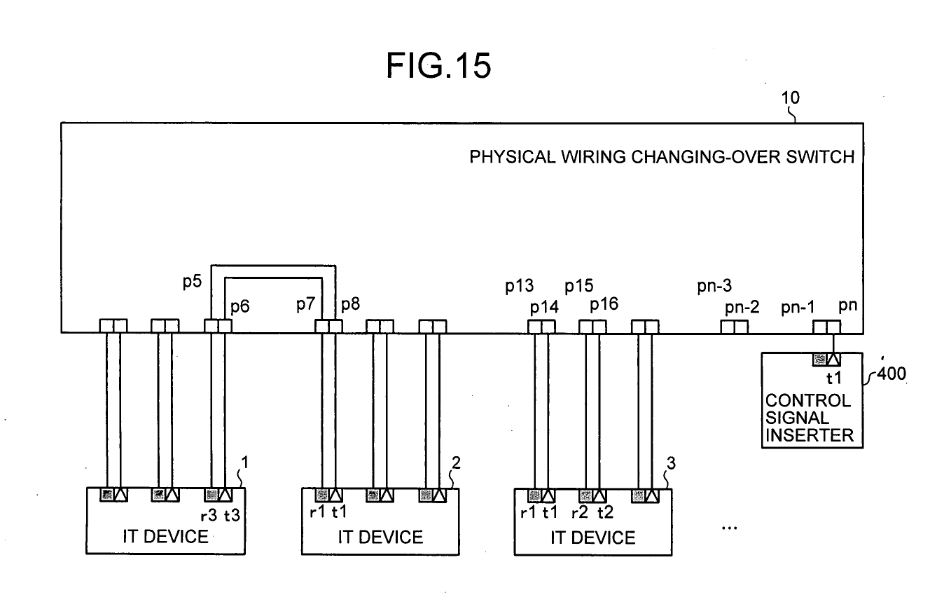

FIG. 14 is a schematic of an internal configuration of the control signal inserter 300. The control signal inserter 300 having received a signal from the IT devices 2 holds the received data bit strings in a buffer memory “b1”, and generates a control signal that instructs suspension of the communications and a storage of the bit strings to be transmitted in a temporary storage area with a control signal generator g1. The control signal inserter 300 then outputs the control signal via a signal inserter “i1” from the transmitter “t2” after the control signal is transmitted, and also outputs the data bit strings stored in the buffer memory “b1” from the transmitter “t2”.

The control signal and the data bit strings output from the transmitter “t2” in the control signal inserter 300 are input in the receiver “r3” in the IT device 1 via the physical wiring changing-over switch 10. Thus, the IT device 1 can receive the data bit strings from the IT device 2, and can also receive the control signal for controlling communications. Signals are also transacted in the same manner from the IT device 1 to the control signal inserter 300, and then, from the control signal inserter 300 to the IT device 2. This operation makes it possible to switch the connection between the IT device 1 and the IT device 2 and change the connection in between the IT devices, after the IT device 1 and the IT device 2 suspend transmission of respective data bit strings.

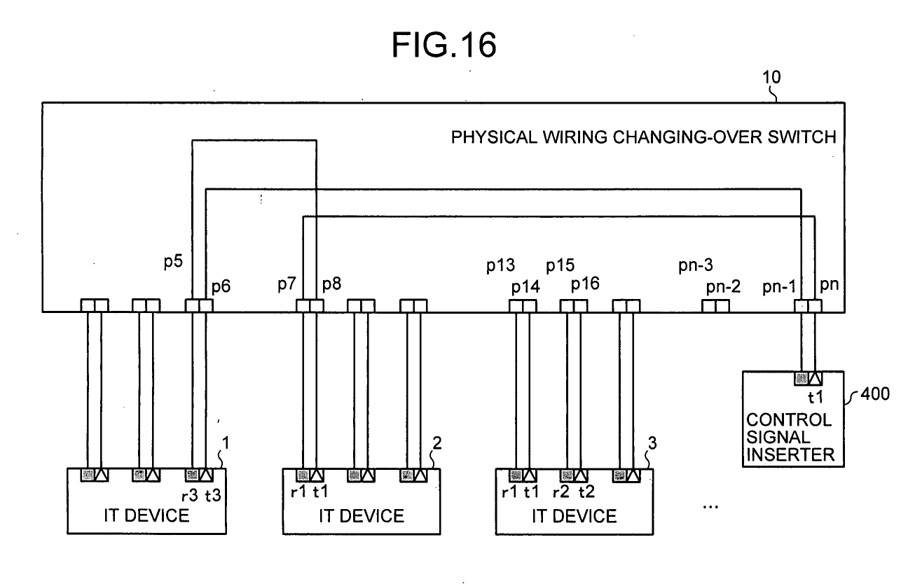

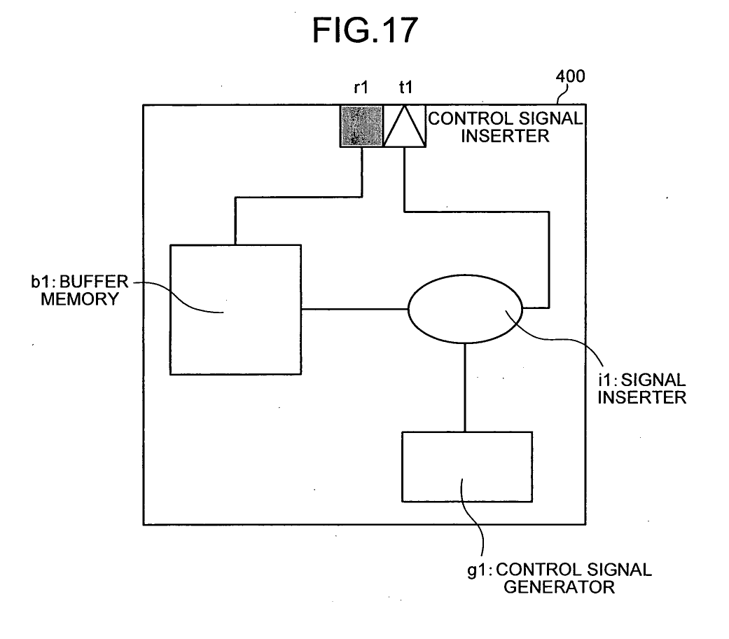

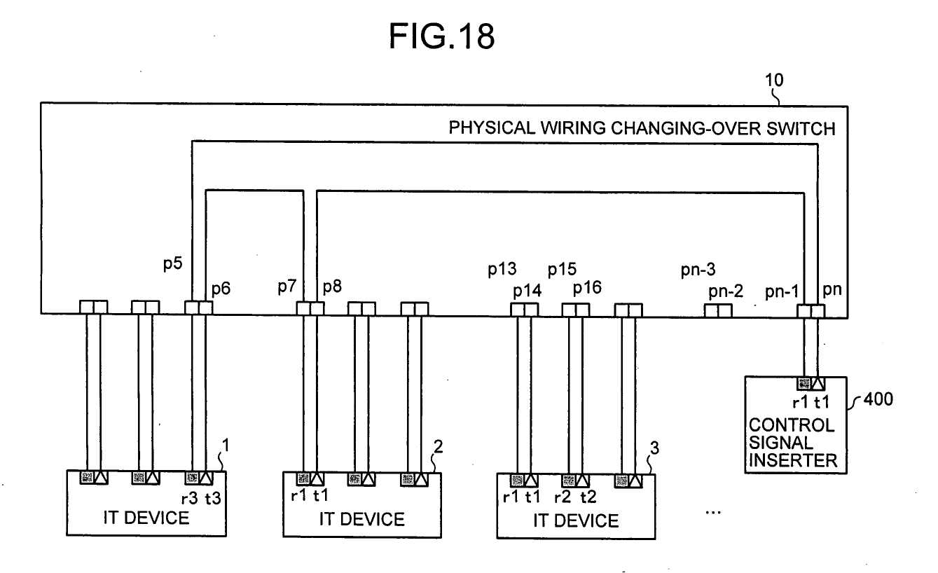

Each of FIG. 15 to FIG. 18 is a schematic of a control signal inserters that include only one set of transmitter and receiver. FIG. 17 is a schematic of internal configuration of a control signal inserter 400 shown in FIG. 15. FIGS. 15 and 16 are schematics for explaining switching of connections of the IT devices by using the control signal inserter 400. Even with this configuration, transmission of the data bit strings from the IT device 1 and the IT device 2.can be suspended, after which the connection between the IT device 1 and the IT device 2 is switched to change the connection in between the IT devices.

As described above, in the embodiment, the communication suspension instructing unit 120 in the controller 100 instructs, before the wiring of the physical wiring changing-over switch 10 is switched, an IT device connected to other IT devices by the physical wiring changing-over switch 10 to suspend communications for a certain period of time and to hold the communication bit strings to be transmitted in a temporary storage area, which can prevent loss of the communication bit strings when the physical wiring is switched.

The present invention has the effect of improving credibility of a network system because loss of communication data is prevented, when physical wiring is switched.

The present invention has the effect of improving credibility of a network system because suspension of communications is securely instructed, and loss of communication data is prevented, when physical wiring is switched.

The present invention has the effect of eliminating the use of control wiring because suspension of communications is instructed without using control wiring, and thereby the control wiring is unnecessary.

The present invention has the effect of controlling load on a network when communications are resumed, because the time for resuming communications of information devices can be controlled.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A network configuring device comprising:
a physical wiring switching unit configured to connect a plurality of information devices to each other, the physical wiring switching unit including a plurality of interface units for connecting the information devices;
a switch controlling unit that controls the physical wiring switching unit to change connection statuses of the interface units of the physical wiring switching unit and the information devices to thereby changing a network topology of the information devices; and
a communication suspension instructing unit that outputs a signal to an information device whereby that information device suspends communications with other information device, wherein the communication suspension instructing unit outputs the signal before the switch controlling unit changes the connection statuses of the interface units.

2. The network configuring device according to claim 1, further comprising control wiring configured to transmit the signal from the communication suspension instructing unit to the information devices.

3. The network configuring device according to claim 1, wherein the communication suspension instructing unit sends the signal to the information devices via the interface units of the physical wiring switching unit.

4. The network configuring device according to claim 3, wherein the interface units of the physical wiring switching unit includes at least one free interface unit to which no information device has been connected, wherein the communication suspension instructing unit sends the signal to the information devices via the free connection interface.

5. The network configuring device according to claim 3, wherein the communication suspension instructing unit instructs the switch controlling unit to cut off the connection between an interface unit and a corresponding information device, and sends the signal to the corresponding information device via connection cut-off interface unit.

6. The network configuring device according to claim 5, wherein the communication suspension instructing unit instructs the switch controlling unit to cut off the connection between interface units and corresponding information devices, and sends the signal to each of the corresponding information devices via connection cut-off interface units.

7. The network configuring device according to claim 3, wherein the communication suspension instructing unit generates the signal by inserting a corresponding command into data transacted in an interface unit used for a connection to other information devices.

8. The network configuring device according to claim 1, wherein the communication suspension instructing unit generates the signal that includes a command for suspension of the communications and a time duration for suspension of the communications.

9. The network configuring device according to claim 8, wherein the communication suspension instructing unit that includes different time durations for different information devices.

10. A method of configuring a network by controlling a physical wiring switching unit configured to connect a plurality of information devices to each other, the physical wiring switching unit including a plurality of interface units for connecting the information devices, comprising:
outputting a signal to an information device whereby that information device suspends communications with other information device; and
controlling, after the outputting, the physical wiring switching unit to change connection statuses of the interface units of the physical wiring switching unit and the information devices to thereby changing a network topology of the information devices.
